(19) United States
(12) Patent Application Publication
(10) Pub. No.: US 2007/0001651 A1
(43) Pub. Date: Jan. 4, 2007

(54) Distributed networks of electric double layer capacitor supervisory controllers and networks thereof

(76) Inventor: Troy Aaron Harvey, Salt Lake City, UT (US)

Correspondence Address: Troy A. Harvey, 7875 Da Vinci Dr., Salt Lake City, UT, 84121, US

(21) Appl. No.: 11/173,481

(22) Filed: Jul. 2, 2005

Related U.S. Application Data
(60) Provisional application No. 60/585,393, filed on Jul. 2, 2004.

(51) Int. Cl. H02J 7/00

(52) U.S. Cl. 320/166

(57) ABSTRACT

Disclosed is an electric double layer capacitor, having a multiplicity of cells occupying a single package, wherein the individual cells are managed and balanced by networkable embedded circuitry also contained within the same package.

### CROSS REFERENCE TO RELATED APPLICATIONS

This application claims the benefit of U.S. Provisional Patent Application No. 60/585,393 entitled “High energy density electric double layer capacitor and method for producing the same” and filed on Jul. 2, 2004 for Troy Aaron Harvey.

### BACKGROUND OF THE INVENTION

1. Field of the Invention

The present invention relates to electric double layer capacitor modules having control circuitry for balancing the charge between electric double layer capacitors that comprise the module. The present invention also relates to the networking of multiple such balancing circuits, so that control is coordinated.

2. Discussion of Prior Art

Because double layer capacitors have a low working voltage (e.g. typically <4 volts), as practical devices they are often connected in series to obtain higher working voltages. Because capacitor manufacturing tolerances are often limited to around +/−10-20%, and aging effects different capacitors disproportionally, series arrays or series-parallel arrays of capacitors must either employ some method of charge balancing between capacitors or suffer a reduced energy storage capacity limited by the smallest capacitor in the array.

The prior approach has been to have end users assemble custom modules comprising individual double layer capacitor (DLC) cells, and engineer cell balancing circuitry at installation. However, this has restricted DLCs from being used in field installations where the end-user in installs the DLCs in an ad-hoc manner. The current art requires the end-user to either develop custom circuitry, or install arrays of pre-manufactured balancing circuits, taking a level of expertise not often available at installation.

One improvement has been to integrate the balancing circuitry on the outside of each cell (U.S. Pat. No. 6,327,137). However, this solution is limited because unless designed specifically for the end application such per-cell balancing circuits often perform inadequately due to the lack of coordination between circuits and/or a charge controller. Further, such uncoordinated circuits are often unable to allow ad-hoc electrical arrangements of cells for end-uses other than a series arrangement (e.g. parallel, series-parallel). Further each cell requires its own hermetic enclosure, two hermetically sealed terminals, and an individual balancing circuit.

### SUMMARY OF THE INVENTION

The present invention has been developed taking the aforementioned problems of electric double-layer capacitor into consideration, the object of which is to provide capacitor arrays contained as singular modules, having embedded multi-purpose charge balancing circuits which can be networked to one another as to coordinate the embedded balancing circuitry so that an end-user can build arrays of such modules in an ad-hoc manner. The present invention also provides a means of networking the control circuitry of said capacitor array modules, one to another and/or to external controllers, as to coordinate the embedded balancing circuitry. The present invention also provides means to embed the control circuitry within the hermetic envelope of the array, eliminating redundant enclosures and terminal seals, reducing manufacturing cost.

### BRIEF DESCRIPTION OF THE DRAWINGS

FIG. 1 shows an illustrative architecture for a double layer capacitor device having a multiplicity of cells, and containing an embedded charge balancing circuit having a communications transceiver with which to network a multiplicity of said controllers together;

FIG. 2 shows an illustrative architecture for a double layer capacitor device having a multiplicity of cells, and containing an embedded charge balancing circuit having a communications transceiver and a unidirectional communications receiver with which to network to a multiplicity of said controllers together using directionality of information to deduce a network topology in self configuring networks;

FIG. 3 shows an illustrative architecture for a double layer capacitor device having a multiplicity of cells, and containing an embedded charge balancing circuit having a top and bottom side communications transceiver with which to network to a multiplicity of said controllers together using directionality of information and/or sub-networks to deduce a network topology in self configuring networks;

FIG. 4 shows an illustrative architecture for a double layer capacitor device having a multiplicity of cells, and containing an embedded charge balancing circuit having a communications transceiver with which to network to a multiplicity of said controllers, and also having a direction detector circuit to determine the directionality of information to deduce a network topology in self configuring networks;

FIG. 5 shows an illustrative architecture for an double layer capacitor device having a multiplicity of cells, and containing an embedded charge controller having a communications transceiver(s) with which to network a multiplicity of said controllers, where communications is modulated onto the power lines of the capacitor;

FIG. 6 shows an embodiment of the type of architecture shown in FIG. 1, using shunt bypass switches to manage the charge on each capacitor;

FIG. 7 shows an embodiment of the type of architecture shown in FIG. 1, using a switch array to shuttle capacitor charge between storage capacitors, using an intermediary capacitor to move the charge;

FIG. 8 shows a charge graph of two capacitors of a capacitor module demonstrating a method of bypass switching capacitors to equalize charge between them, under a constant power charging conditions with a simultaneous load;

FIG. 9 shows a charge graph of two capacitors of a capacitor module, demonstrating a method of bypass switching capacitors to equalize charge between them;

FIG. 10 shows a charge/discharge graph of two capacitors of a capacitor module, demonstrating a method of bypass switching capacitors to equalize charge between them, where equalization occurs between a voltage threshold and the maximum capacitor voltage;

FIG. 11 shows a charge graph of two capacitors of a capacitor module demonstrating a method of bypass switching capacitors, once one capacitor has reached top-of-charge, to equalize charge between them;

FIG. 12 shows a charge graph of two capacitors of a capacitor module demonstrating a method of charge shuttling between capacitors to equalize charge between them;

FIG. 13 shows a charge/discharge graph of two capacitors of a capacitor module demonstrating a method of charge shuttling between capacitors to equalize charge between them, during either charge or discharge when the voltage of one of the capacitors is above a threshold voltage;

FIG. 14 shows a simple embodiment of the type of architecture shown in FIG. 6, in schematic form;

FIG. 15 shows another simple embodiment of the type of architecture shown in FIG. 7, in schematic form;

FIG. 16 shows another embodiment of the type the type of architecture shown in FIG. 7, having a small switch count, in schematic form;

FIG. 17 shows another embodiment of the type the type of architecture shown in FIG. 7, using an inductor shuttle instead of a capacitor, in schematic form;

FIG. 18 shows an example state diagram for a simple charge balancing control circuit;

FIG. 19 shows an example state diagram for a charge balancing control circuit;

FIG. 20 shows a network diagram of a master-slave network topology, having a head node managing a network of capacitor modules;

FIGS. 21A to 21B show network diagrams for serial and parallel networks of capacitor modules;

FIGS. 22A to 22B show network diagrams for serial and parallel networks of capacitor modules having directional detection of network topology;

FIGS. 23A to 23C show production steps illustrating the process of making a series connected stack of electric double-layer capacitors according to an embodiment of the current invention using polymer pouch packaging arranged into a single capacitor high-voltage module having an embedded balancing circuit;

FIGS. 24A to 24C show production steps illustrating the process of making a series connected bipolar stack of electric double layer capacitors according to an embodiment of the current invention arranged into a single capacitor high-voltage module having an embedded balancing circuit;

FIGS. 25A to 25C show production steps illustrating an injection molding process of making a series connected bipolar stack of electric double layer capacitors according to an embodiment of the current invention arranged into a single capacitor high-voltage module having an embedded balancing circuit;

### DESCRIPTION OF THE PREFERRED EMBODIMENTS

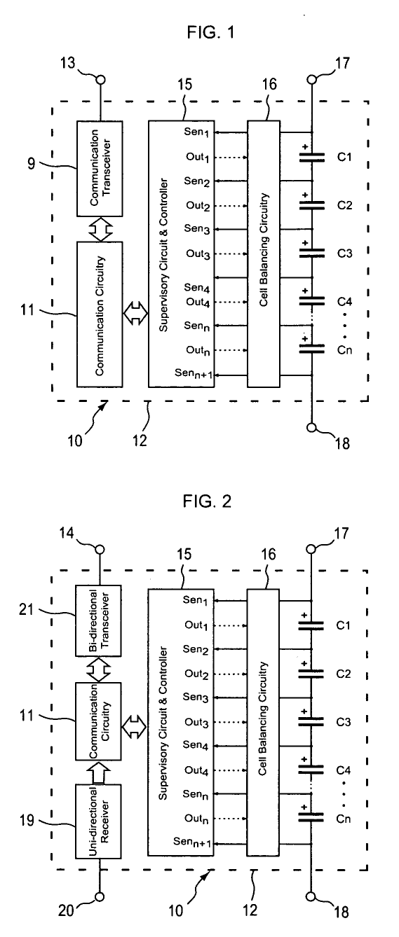

Explanation will be made below with reference to FIGS. 1-25 for illustrative embodiments concerning electric double-layer capacitor modules having a multiplicity of cells and networkable charge balancing circuitry; architectures and methods of operation for the charge balancing circuitry; and the method for producing the same according to the present invention.

Architecture

In its fundamental form, the electric double-layer capacitor of the present invention, contains two or more capacitors connected in electrical series or series-parallel, wherein the array of capacitors are housed together in a single module having also circuitry to: balance the state-of-charge of each capacitor or each parallel set of capacitors, and provide a means of communications to network a multiplicity of such EDLC modules to coordinate units or coordinate one or a number of networked modules to a head node, typically a charge controller.

An architectural embodiment of the present invention can be seen in FIG. 1. Wherein the electric double layer capacitor module 10, is contained within a single enclosure 12. Wherein the enclosure contains an array of two or more electric double layer capacitors C1, C2, C3, C4 . . . Cn. Power terminals 17 and 18, provide means of electrical connection of said capacitor array and project through, or are integral to, the module envelope 12. The EDLCs balancing is performed by Cell Balancing Circuitry 16, as controlled by the Supervisory Circuit & Controller 15. The module utilizes Communication Circuitry 11 and a Communication Transceiver 9 to network the Supervisory Circuit & Controller 15 to other modules or an external controller via the Network Connection 13.

Another architectural embodiment of the present invention can be seen in FIG. 2. Wherein the electric double layer capacitor module 10, is contained within a single enclosure 12. Wherein the enclosure contains an array of two or more electric double layer capacitors C1, C2, C3, C4 . . . Cn. Power terminals 17 and 18, provide means of electrical connection of said capacitor array and project through, or are integral to, the module envelope 12. The EDLCs balancing is performed by Cell Balancing Circuitry 16, as controlled by the Supervisory Circuit & Controller 15. The module utilizes Communication Circuitry 11 and one Bi-directional Transceiver 21 connected to the positive side network terminal 14 and another Unidirectional Transceiver 19 which is connected to the negative side Network Connection 20. In the example shown, the bidirectional transceiver is associated with the positive side of the capacitor and the unidirectional transceiver is associated with the negative side of the capacitor, though this is an arbitrary assignment, and could be associated oppositely. Using this arrangement, information about the network topology is inherent in the directionality of the network signals. That is, in parallel connected modules signal transmission occurs through the positive side and is received through the positive side. Whereas is series connected modules, transmission occurs through the positive side and is received though the negative side. In this way, the balancing and control circuitry networks easily accommodate parallel module arrays, series module arrays, and complex series-parallel module arrays.

Another architectural embodiment of the present invention can be seen in FIG. 3. Wherein the electric double layer capacitor module 10, is contained within a single enclosure 12. Wherein the enclosure contains an array of two or more electric double layer capacitors C1, C2, C3, C4 . . . Cn. Power terminals 17 and 18, provide means of electrical connection of said capacitor array and project through, or are integral to, the module envelope 12. The EDLCs balancing is performed by Cell Balancing Circuitry 16, as controlled by the Supervisory Circuit & Controller 15. The module utilizes Communication Circuitry 11 and one Bi-directional Transceiver 21 connected to the positive side Network Connection 14 and another Bi-directional Transceiver 21 which is connected to the negative side Network Connection 20. Using this arrangement, information about the network topology is inherent in the directionality of the network signals, through means such as subneting. Through this method, devices connected in parallel share a single communication network, whereas devices connected in series, the signals are routed though the series connected module having both top and bottom side connection in the series array. In this way, the balancing and control circuitry networks easily accommodate parallel module arrays, series module arrays, and complex series-parallel module arrays.

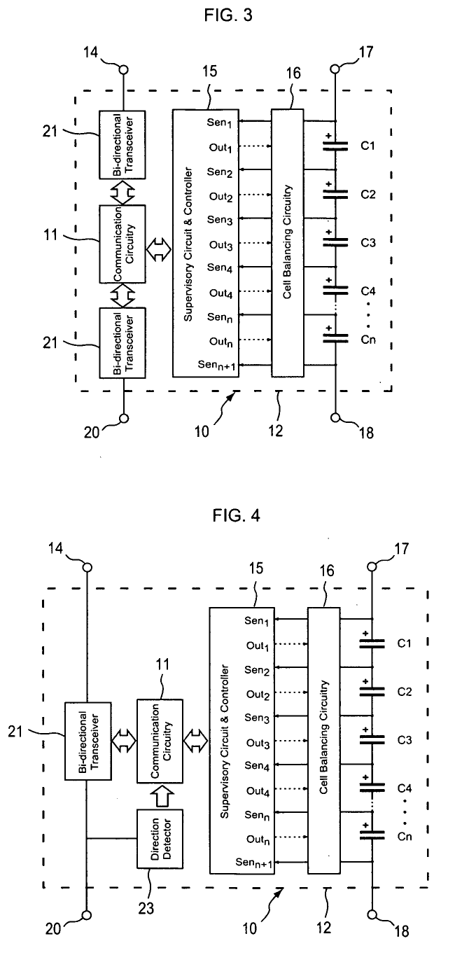

Another embodiment of the function of the present invention can be seen in FIG. 4, a variation of the architecture shown in FIG. 2, though only using one transceiver. Wherein the electric double layer capacitor module 10, is contained within single enclosure 12. Wherein the enclosure contains an array of two or more electric double layer capacitors C1, C2, C3, C4 . . . Cn. Power terminals 17 and 18, provide means of electrical connection of said capacitor array and project through, or are integral to, the module envelope 12. The EDLCs balancing is performed by Cell Balancing Circuitry 16, as controlled by the Supervisory Circuit & Controller 15. The module utilizes Communication Circuitry 11 and one Bi-directional Transceiver 21 connected to both the Network Connections 13 and 20. By using a Direction Detector 23 circuit, the Communication Circuitry 11 determines the network topology. For example, in parallel connected modules signal transmission occurs through the positive side and is received through the positive side (though it could be established oppositely). Whereas in series connected modules, transmission occurs through the positive side and is received though the negative side. In this way, the balancing and control circuitry networks easily accommodate parallel module arrays, series module arrays, and complex series-parallel module arrays.

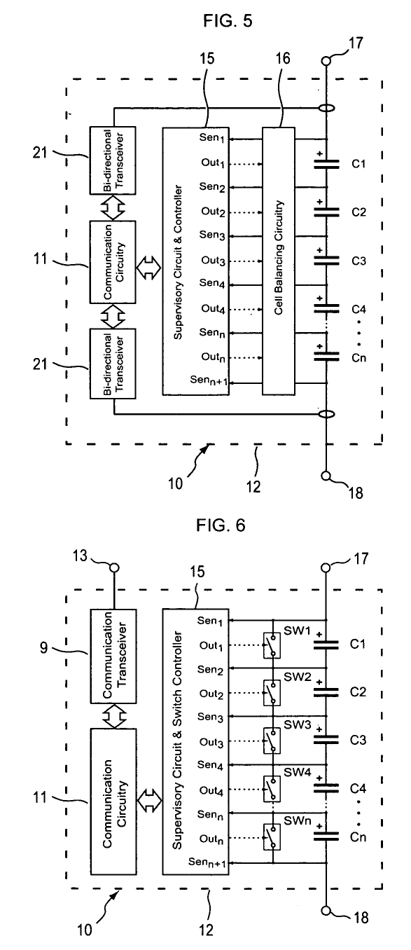

Another embodiment of the function of the present invention can be seen in FIG. 5, a variation of the architecture in FIG. 3, using a modulated network signal over the power terminals of the capacitor module. While this embodiment shows a variation of the architecture in FIG. 3, the methodology of modulating the network signal could be applied to any of the architectures or embodiments of the present invention. Wherein the electric double layer capacitor module 10, is contained within enclosure 12. Wherein the electric double layer capacitor module 10, is contained within single enclosure 12. Wherein the enclosure contains an array of two or more electric double layer capacitors C1, C2, C3, C4 . . . Cn. Power terminals 17 and 18, provide means of electrical connection of said capacitor array and project through, or are integral to, the module envelope 12. The EDLCs balancing is performed by Cell Balancing Circuitry 16, as controlled by the Supervisory Circuit & Controller 15. The module utilizes Communication Circuitry 11 and one Bi-directional Transceiver 21 connected to the positive power terminal 17 and another Bi-directional Transceiver 21 which is connected to the negative power terminal 18 via modulation or coupling of the network signal onto the power terminals. Such modulation may include amplitude, frequency, phase modulation techniques, or even direct digital pulse switching of the power source. Using this arrangement, information about the network topology may be inherent in the directionality of the network signals, if implemented in such an embodiment (e.g. FIGS. 2-5).

In an embodiment of the current invention as described as above, the enclosure 12, provides a hermetical seal creating a barrier for substantially limiting the permeation of water vapor into the module. In this preferred embodiment, the balancing circuitry is embedded within the hermetic envelope eliminating the need for per cell electrical feedthroughs projecting through the envelope. By so doing, the present invention eliminates redundant per cell envelopes as well, and limits the number of feedthroughs to the EDLC power terminals and the additional signal terminals for networking the balancing circuitry of each module to other modules or control node(s).

The network signal of the current invention may be digital in nature (e.g. high/low digital signal or an open collector digital switch closure) to notify top-of-charge in the simplest case, or may contain coded symbolic data as to indicate a number of control messages, controller status or control states: for example, whether the charge controller is currently charging or not-charging, switch synchronization, or what number of bypass switches are engaged. Alternatively, this status and control information may also be transmitted separately over individual connections using a digital true/false indication each having its own terminal.

In a simple embodiment, the communications circuitry and transceiver are nothing more than a open collector transistor output buffer providing a digital state-of-charge indicator to signal the charge controller to stop charging, once the smallest capacitor in the array has reached top-of-charge. In this case no communication occurs between EDLC modules, each have open collector outputs tied together on the signal line, and the first capacitor to hit top-of-charge stops the charging of the whole bank. Such a signal can also be coded or coupled onto one or both of the power lines as described above.

In the very simplest embodiment, no explicit signaling is used and the unit is sealed with no external network connection, and the modules balancing circuits “compete” to maintain balance without cooperation. This may be sufficient if the charge time is sufficiently slow, the EDLC capacitance tolerances are small, and the EDLC bank is used without frequent interruptions in service.

In the embodiments where the information is coded into symbols which can be transmitted, a number of methodologies may be used for such coding, including byte codes, nibble codes, pulse width modulated codes, pulse frequency codes, trinary or quadarnary level codes, frequency modulated codes, phase modulated codes, etc. The coding may also utilize a network protocol format, where the protocol and physical layer are designed around either master-slave (head-node/charger to EDLC modules) or peer-to-peer (module to module) network topology. Many protocol and physical layer designs can be used, though preferably protocol designs should be suitable for inexpensive 4 or 8 bit microcontroller implementations. Example protocols and physical layer implementations include I2C, One-wire (Maxim semiconductor), SPI, Devicenet, USB, CAN, RS-485 with open collector outputs and a simple protocol implementation, low voltage output drivers with optical coupler input and a simple protocol implementation, optical links using either optical fiber or direct line-of-sight, and etc.

Network Diagrams

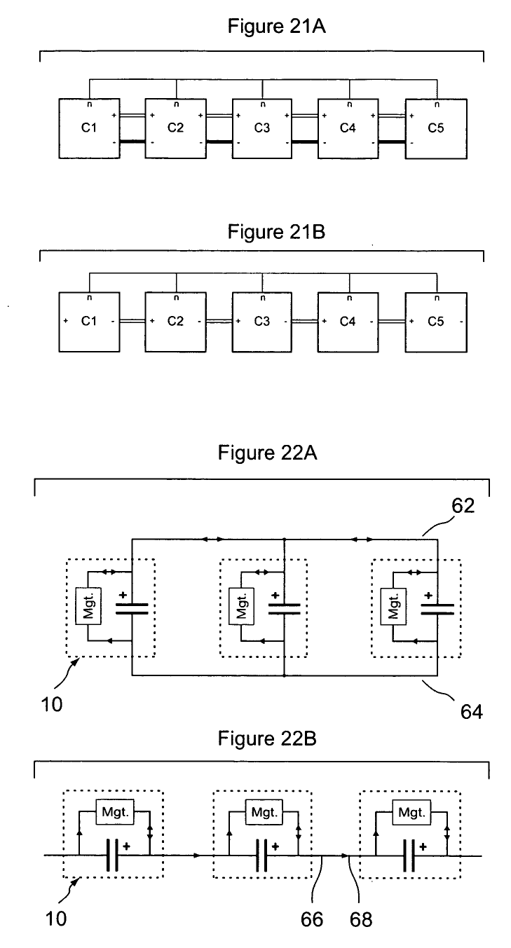

Three embodiments of networking independent array modules are described below. The first means is to have a head node or charge controller master the network and manage co-ordination of the arrays in the network such as the embodiment shown in FIG. 20. The head node may indicate timing for bypass switching, coordinate switch synchronization, query operational status of units, and so on. A second means is to provide cooperative network logic in the modules themselves, so that they may operate without an explicit master such as the embodiment shown in FIG. 21A for a parallel array and FIG. 21B for a serial array. A third means is to have a loose coupled network of modules with or without a head node, having a network diagram either as FIG. 20 or FIG. 21, wherein each module operates largely independently, networking is providing only for the most basic signaling requirement (i.e. capacitor in a array has reached TOC) and is not explicitly coordinated by a network protocol.

FIGS. 22A and 22B show examples of directionality of network signaling carrying topology information of the network. The network diagram in FIG. 22A show the modules 10 each having a capacitor array and management circuitry embedded in the module. The network signaling occurs on the top-side 62 and the signal reception also occurs on the top side 62, where no signal is received on the bottom side 64, indicating to the capacitors that the topology is parallel. In the network diagram in FIG. 22B, the modules 10 each have a capacitor array and management circuitry embedded in the module. The network signaling occurs on the top-side 66 of one module and the signal reception occurs on the bottom side of the next module 68, indicating to the capacitors that the topology is series.

Cell Balancing

There are a number of charge balancing methodologies that lend themselves to array modules. Particularly modules for use in for bulk energy storage applications have unique requirements. In such applications it may be allowable that it takes hours or even days for the capacitor array to finally come into balance. Once in balance, cells tend to stay in balance, needing only periodic maintenance by the balancing circuits to maintain that balance.

One such architectural embodiment can be seen in FIG. 6, having switches (SW1-SWn) bypassing each of the EDLCs (C1-Cn) in the module. The Supervisory Circuit & Switch Controller 15 monitors the state-of-charge on each of the EDLCs. For example EDLC C1 is measured across Sen1 and Sen2. When switched the capacitor coupled to the switch is bypassed allowing the charge current to flow to the remaining capacitors in the array. Further, the switch can discharge the capacitor which it bypasses, depending on the resistance of the switch, the resistance of the capacitor, and the current flowing through the array. Each switch may be, but is not limited to, a bipolar transistor, FET, MOSFET, IGBT, or photorelay. Further each switch may contain a resistance element and/or diode.

There are several means of switching the bypass switches in the present invention. In one method the switches of the capacitors having the highest voltages relative to the other capacitors, are pulsed periodically during the charge cycle until equality or a margin of equality is reached. After which the switches are periodically pulsed to compensate for self-discharge differences. It is preferred that the switch pulsing is controlled by a form of pulse frequency modulation where the pulse width multiplied by the minimum allowed pulse frequency is below the heat dissipation rate of the module. The pulse frequency modulation may also be a fixed duty cycle and fixed time pulse modulation in its simplest form.

One embodiment of this method is shown in FIG. 8, wherein two capacitor elements of a capacitor array are shown in a charge graph progressively equalizing using the periodic pulse modulated bypass switch across the smaller capacitor, EDLC 1, having a voltage and thus state-of-charge (SOC) greater than the other capacitor EDLC 2. The example of the embodiment of the present invention shown in the graph shows two capacitors being charged by a constant power source having a simultaneous load drawing power, such that when EDLC 1 reaches MaxV, and the controller stops charging the array, the capacitors start to discharge. Optionally, the circuit may provide hysteresis such that when upon discharge when a capacitor reaches the lower threshold Vt, the charge source is reapplied. The periodic pulse modulation is shown in the graph in the areas shaded 22, where in this example during modulation the bypassed capacitor EDLC 1, substantially doesn't charge and may discharge through the switch and its associated resistor depending on the balance of charge power, current, switch resistance, and capacitor ESR. While EDLC 1 is bypassed, EDLC 2 here charges at a faster rate due to the nature constant power source. The result of the quickened charge rate of EDLC 2, and the arrested charge of EDLC 1 allow the capacitors over time to approach charge equality.

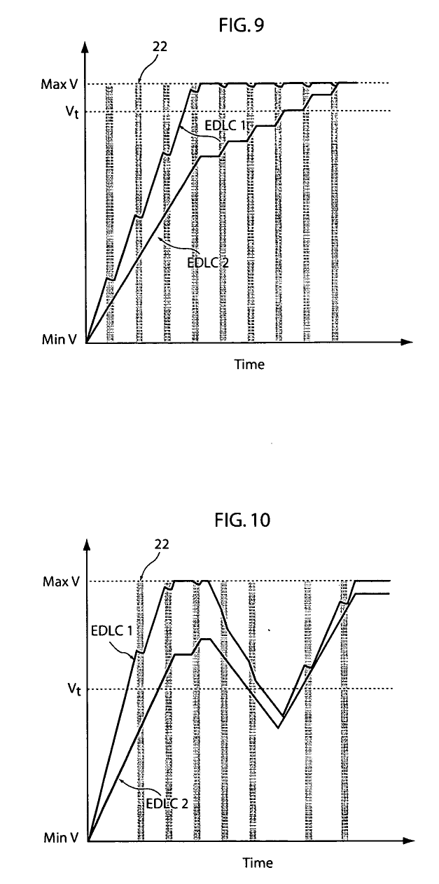

Another embodiment of this method is shown in FIG. 9, wherein two capacitor elements of a capacitor array are shown in a charge graph progressively equalizing using the periodic pulse modulated bypass switch across the smaller capacitor, EDLC 1, having a voltage and thus SOC greater than the other capacitor EDLC 2. The periodic pulse modulation is shown in the graph in the areas shaded 22. During modulation the bypassed capacitor EDLC 1, substantially doesn't charge or as in this example partially discharges through the switch and it's associated resistance depending on the balance of charge power, current, switch resistance, and capacitor ESR. While EDLC 1 is bypassed, EDLC 2 here continues charging. The result of the continued charge rate of EDLC 2, and the arrested charge of EDLC 1 allow the capacitors over time to approach charge equality. Once the higher SOC capacitor reaches MaxV, the modulation continues, partially discharging EDLC 1, and increasing the charge on EDLC 2, until a margin of equality is reached. Optionally, the circuit may provide hysteresis such that multiple modulated bypass switching of EDLC 1 are required from MaxV to discharge EDLC 1 below the threshold Voltage Vt before a charge source is reapplied charging the array.

Another embodiment of this method is shown in FIG. 10, wherein two capacitor elements of a capacitor array are shown in a charge graph progressively equalizing using the periodic pulse modulated bypass switch across the smaller capacitor, EDLC 1, having a voltage and thus SOC greater than the other capacitor EDLC 2. In this embodiment the balancing doesn't occur until the capacitor with the highest voltage (EDLC 1) is above a threshold voltage Vt, permitting simplified control logic. In this embodiment the capacitors may be balanced during both charge and discharge, and as shown in the graph the capacitors balancing occur over multiple cycles until coming into a margin of balance. The periodic pulse modulation is shown in the graph in the areas shaded 22. During modulation the bypassed capacitor EDLC 1, substantially doesn't charge or as in this example partially discharges through the switch and its associated resistance depending on the balance of charge power, current, switch resistance, and capacitor ESR. While EDLC 1 is bypassed, EDLC 2 here continues charging. The result of the continued charge rate of EDLC 2, and the arrested charge of EDLC 1 allow the capacitors over time to approach charge equality. Once the higher SOC capacitor reaches MaxV, the modulation continues, partially discharging EDLC 1, and increasing the charge on EDLC 2, until a margin of equality is reached.

In another method the switch is turned on when the adjacent capacitor reaches top-of-charge, causing a bypassing and/or discharge of the switched capacitor with each capacitor held until all capacitors are within a margin of equality. After which the switches are periodically engaged to compensate for self-discharge differences. Or alternatively both methods may be used together.

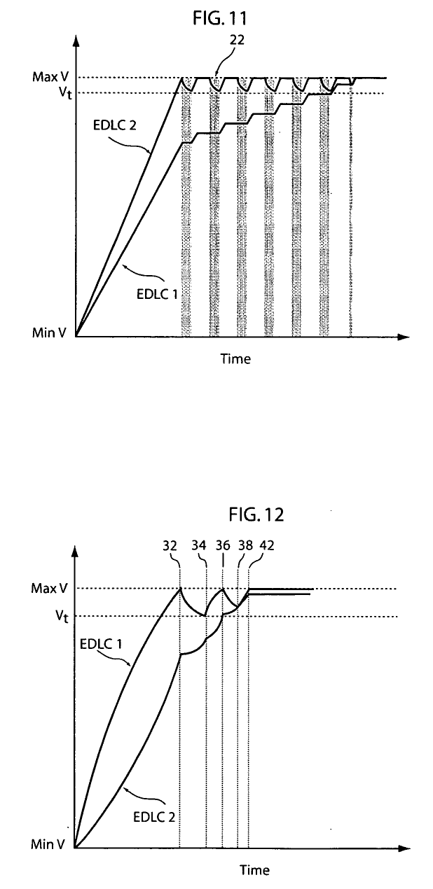

An embodiment of this method is shown in FIG. 11, wherein two capacitor elements of a capacitor array are shown in a charge graph progressively equalizing using the periodic pulse modulated bypass switch across the smaller capacitor, EDLC 1, having a voltage and thus SOC greater than the other capacitor EDLC 2. In this embodiment the balancing only occurs once the capacitor with the highest voltage reaches the maximum allowed potential MaxV. After the capacitor with the highest SOC reaches MaxV, charging of the array is halted, the bypass switch pulse discharges (22) the capacitor(s) with the highest SOC, until their potential falls below a threshold hysteresis limit Vt, after which charging resumes until the capacitor(s) with the highest SOC reach the MaxV limit. The cycle is repeated until the capacitors in the array reach a margin of equality.

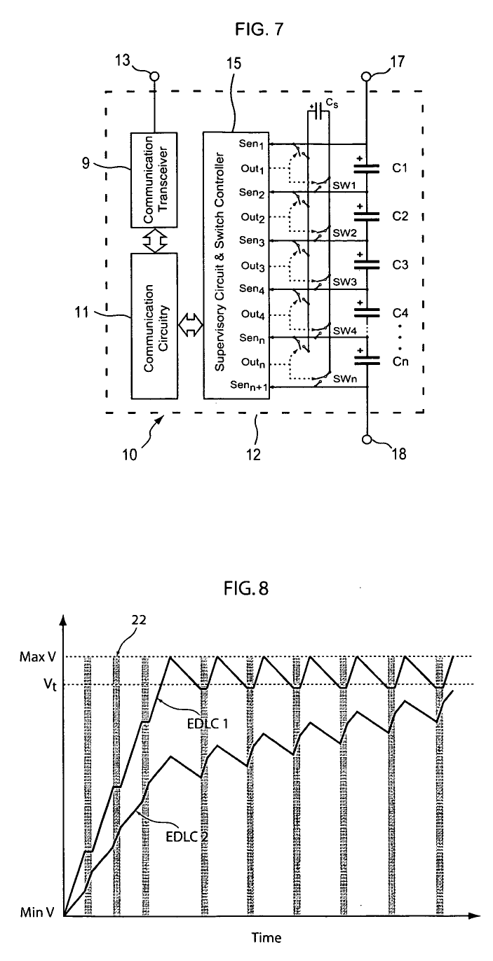

Another architectural embodiment of the present invention can be seen in FIG. 7, having a switch matrix (SW1-SWn) that can connect a temporary shuttle capacitor Cs, or other energy storage element such as an inductor, in parallel circuit with any of the storage EDLCs (C1-Cn) depending on which switches are closed. The Supervisory Circuit & Switch Controller 15 may monitor the state-of-charge on each of the EDLCs. For example EDLC C1 is measured across Sen1 and Sen2. When the pair of switches labeled SW1 are closed the capacitor C1 is coupled to the shuttle capacitor Cs, charging Cs. After opening the switches SW1, and closing switches SW2 for example, the charge on Cs can be transferred to EDLC C2, reducing the charge difference between two unequally charged EDLCs. Each switch may be a bipolar transistor, FET, MOSFET, IGBT, or photorelay. Further each switch may contain a diode.

Further, an inductive element can be added together with the shuttle capacitor to improve the charge/discharge efficiency of the shuttle capacitor.

Furthermore, using column selection of switches, for instance the left most column switches of switches SW1 and SW2, the same architecture can be used to provide bypass switches as well as capacitor shuttling allowing a hybrid method charge balancing circuit. Thus such an implementation would also be able to provide the switch embodiments explored in FIGS. 8-11.

A number of algorithms may be used for balancing the EDLCs.

In one algorithm the EDLCs are tested one to another determining the position of the highest and lowest voltage EDLCs which are balanced, then the circuitry determines the position of the next highest and lowest voltage EDLCs and process is repeated until all EDLCs are brought within a margin of balance.

In another algorithm the EDLCs are tested one to another determining the position of the highest voltage EDLCs which is then tested against each of the EDLC is the array, stopping for a period of time to balance EDLCs that have a voltage difference above a certain threshold when compared to the highest voltage EDLC. The process is repeated until all EDLCs are brought within a margin of balance.

In another algorithm the EDLCs are tested one to another determining the position of the lowest voltage EDLCs which is then tested against each of the EDLC in the array, stopping for a period of time to balance EDLCs that have a voltage difference above a certain threshold when compared to the lowest voltage EDLC. The process is repeated until all EDLCs are brought within a margin of balance.

In another algorithm the EDLCs are tested one to another determining the average voltage of the EDLCs in the array. All EDLCs in the array are tested against the average voltage, stopping for a period of time to balance EDLCs that have a voltage difference above a certain threshold when compared to the average voltage. The process is repeated until all EDLCs are brought within a margin of balance.

The capacitor shuttle embodiment described above, may employ other balancing algorithms. In the simplest of which, the shuttle capacitor Cs is sequentially connected in parallel which each capacitor in series in round robin fashion until, all EDLCs are brought within a margin of balance, without explicitly needing to test the voltage differences of the EDLCs in the array.

An embodiment of the shuttle method is shown in FIG. 12, wherein two capacitor elements of a capacitor array are shown in a charge graph progressively equalizing using charge shuttling to move charge from the smaller capacitor EDLC 1, to the capacitor EDLC 2. The charge shuttling pictured in the graph is continuous or a semi-continuous back and forth shuttle process progressively slowing the charging of the smaller capacitor EDLC 1, and speeding the charging of the large capacitor EDLC 2. The switch modulation for shuttling may be a fixed frequency or a pulse frequency modulation stopping at MaxV or continuing until the capacitors reach a margin of balance. In the present embodiment, when the capacitor begins charging the balancing circuitry engages at a point where the circuit has sufficient working potential to operate. When the smaller capacitor EDLC 1 reaches top-of-charge (TOC) 32 the charge source is signaled to stop charging the array. The charge shuttling slowly discharges EDLC 1 and charges EDLC 2 until the smaller capacitor EDLC 1 reaches a optional threshold voltage Vt 34 at which point the charging circuit is engaged, charging while balancing continuously until the EDLC with the higher SOC again reaches MaxV 36. Again the cycle is repeated until after balancing EDLC 1 is within a predetermined margin of SOC with EDLC 2 at time 38. After which the charge source is reapplied until the capacitors reach TOC 42 within a margin of equality.

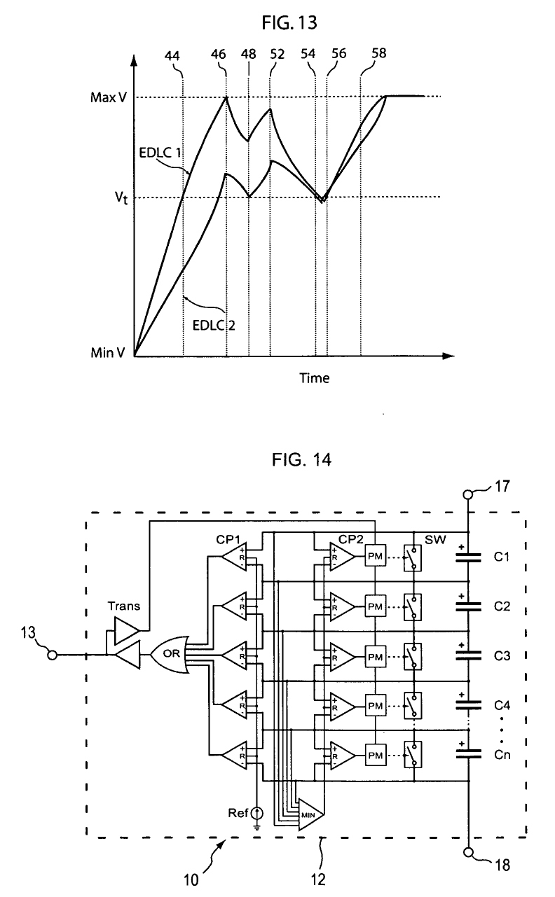

Another embodiment of this method is shown in FIG. 13, wherein two capacitor elements of a capacitor array are shown in a charge graph progressively equalizing using charge shuttling to move charge from the smaller capacitor EDLC 1, to the capacitor EDLC 2. The charge shuttling pictured in the graph is a continuous or semi-continuous back and forth shuttle process progressively slowing the charging of the smaller capacitor EDLC 1, and speeding the charging of the large capacitor EDLC 2. The switch modulation for shuttling may be a fixed frequency or a pulse frequency modulation stopping at MaxV or continuing until the capacitors reach a margin of balance. In the current embodiment the charge shuttling is initiated once the capacitor having the highest potential passes a threshold voltage Vt 44. When the smaller capacitor EDLC 1, having the highest potential, reaches TOC 46 the charge source is signaled to stop charging the array. Once the charge current stops, the load becomes dominate causing EDLC 1 and EDLC 2 to discharge. During discharge, while the capacitor(s) having the highest SOC are still above the threshold voltage, charge shuttling continues, accelerating the discharge of the smaller capacitor EDLC 1 and slowing the discharge of the larger capacitor EDLC 2. In the current example, having a complex combination charge source and load, the charge/load balance changes at time 48, renewing the charge cycle. The charge cycle repeats as before, until the charge/load balance changes again 52, discharging the array. The capacitors again charge shuttle balance themselves while discharging until they drop below the threshold voltage 54, after which they discharge normally until the charge/load balance changes again, bringing the EDLC SOC above threshold voltage 56. At this point the capacitors are balanced within the set margin, disabling the balancing circuitry. The balancing circuits are re-enabled after the EDLC SOC diverges sufficiently, time 58, as to bring the capacitor back into a margin of equality.

The preferred embodiment uses hysteresis at Vt where the charge balancing circuitry is engaged at a lower voltage during charging, but is disengaged at a higher voltage during discharge. Also the threshold voltage can be combined with slope direction detection or average slope over a arbitrary timeframe to engage the balancing circuits when above the threshold and during charge, but not during discharge.

It is also possible to use slope prediction for each of the capacitors to determine, regardless of state-of charge, whether balancing is warranted. Since capacitors that are balanced near top-of-charge do not need to be balanced as their state-of-charge drops even though their respective voltages diverge, this way unnecessary balancing can be avoided.

It is also possible to calculate the margin of acceptable equality based on the current state of charge, where the margin of acceptable equality preferably increases at lower SOC.

### CONTROLLER EXAMPLES

FIG. 14 shows a simple embodiment of the architecture described in FIG. 6, where a capacitor module 10, contains a capacitor array C1-Cn and charge balancing circuitry all within an enclosure 12, which is preferably hermetically sealed. Wherein this embodiment each capacitor C1 is bypassed by a switch SW which may be comprised of a bipolar transistor, FET, MOSFET, IGBT, or photorelay. Further each switch may also comprise a resistance element and/or diode. Each switch is engaged by a pulse modulation circuit PM controlled by a comparator CP2. Each comparator compares the voltage across the capacitor it is connected to as a function of the other capacitors in the stack. In this embodiment the comparison voltage is provided by the MIN circuit which selects the capacitor with the lowest voltage, as the basis of comparison for the capacitors CP2. This function could also be an average, mean, harmonic mean, or another function of the capacitors in the array. When the voltage difference between the function MIN and the voltage of the capacitor exceeds a set threshold, the comparator CP2 signals the modulation circuit PM to modulate the bypass switch, lowering the SOC of the selected capacitor relative to the other capacitors in the stack.

Each capacitor also has a comparator CP1 which compares the voltage of the capacitor C1 with a reference voltage determined to be the maximum allowable cell voltage minus any margin of error. When any capacitor cell reaches this set point, the signal as logically ORed by the gate OR and buffered by TRANS is transmitted onto the Network 13. This signal indicates to the charge controller to stop charging, and optionally to each of the modules that TOC has been reached allowing individual modules to modify their behavior. Trans may by a two-way transceiver, or in the simplest case a top-of-charge signal to the charge controller with no two way logic.

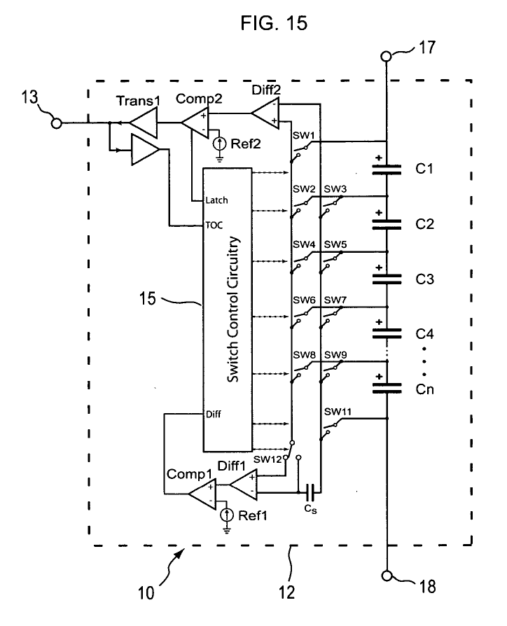

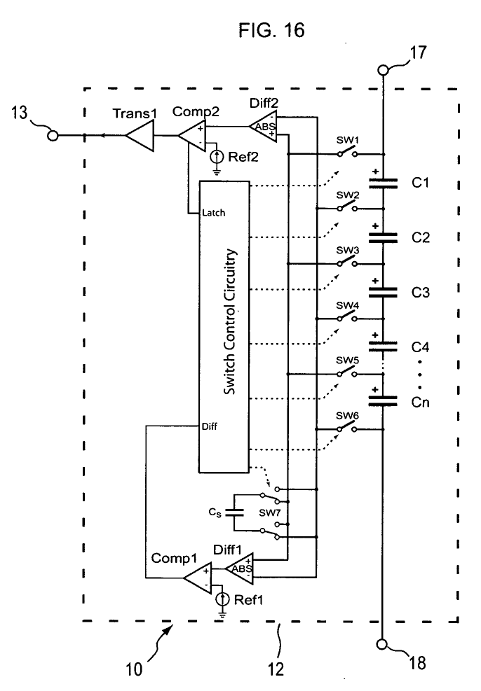

Though FIG. 14 shows fixed individual comparators per EDLC cell, the preferred embodiment has a single comparator with a multiplexing switch ladder, similar to the one shown in FIG. 15 or 16.

FIG. 15 shows an embodiment of the architecture described in FIG. 7, where a capacitor module 10, contains a capacitor array C1-Cn and charge balancing circuitry all within an enclosure 12, which is preferably hermetically sealed. Where in this embodiment each capacitor C1-Cn is connected by a switch matrix (e.g. via switch pairs such as SW1 & SW3) to a shuttle capacitor CS. Wherein each switch may be comprised of a bipolar transistor, FET, MOSFET, IGBT, or photorelay. Further, each switch may also comprise a resistance element and/or diode. Switches are switched in pairs to charge the shuttle capacitor CS, for example SW1 and SW3 connect C1 in parallel with CS. After charging the shuttle capacitor CS, the switches SW1 and SW2 are then opened, after which the comparator switch SW12 disconnects from CS, and connects to the input of Diff1. Then SW2 and SW5 are closed so the amplifier Diff1 measures the voltage difference between C2 and the voltage of C1 as stored in CS. Subtraction circuit Diff1 sends the voltage difference between the two capacitors being tested, in this case C1 and C2, to the comparator Comp1, which compares the voltage to the reference voltage Ref1. If the voltage difference exceeds the threshold voltage set by Ref1, the comparator signals the Switch Control Circuitry 15 which maintains an algorithm for tracking and balancing the capacitor array. For instance if the SOC of C2 is less than C1, the switch SW12 is toggled to connect the shuttle capacitor CS in parallel with C2, thus charging C2 by the charge difference amount stored in CS. The shuttle charging step can be repeated until the capacitors come into a margin of charge balance, or the process can be implemented with a number of algorithms to progressively bring the capacitors into charge balance as the circuitry repeatedly scans through the array.

FIG. 16 shows another embodiment of the architecture described in FIG. 15, having a small switch count. The operation is as described above, with a switch ladder having only one switch per EDLC C1-Cn alternatively connected to two buses that terminate in the polarity switch SW7 attached to the shuttle capacitor Cs. The polarity switch SW7 allows random access of any EDLC in the array to be connected to the shuttle capacitor Cs in the correct polarity, while using only n+2 switches, where n is equal the number of EDLCs. In this embodiment, the module 10 provides only a simple unidirectional top-of-charge digital indication via the network terminal 13, to indicate when one cell in the array has reached TOC.

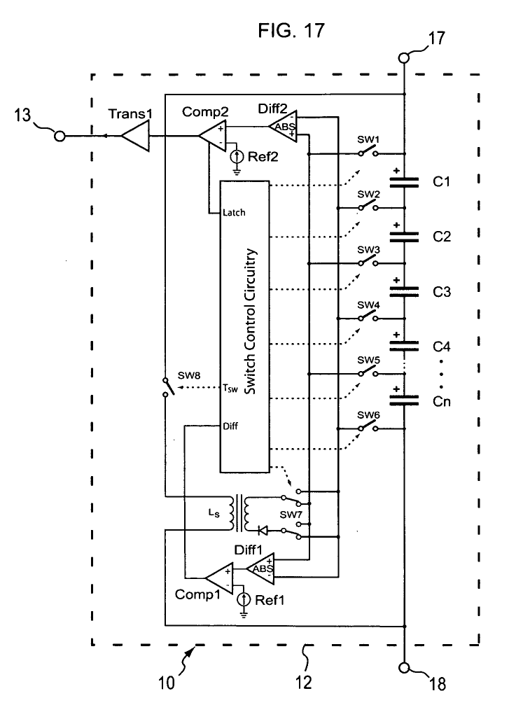

FIG. 17 shows another embodiment of the architecture described in FIG. 16, having an inductive shuttle storage element Ls. The operation is as described above, with a switch ladder having only one switch per EDLC C1-Cn alternatively connected to two buses that terminate in the polarity switch SW7 attached to the shuttle inductive element Ls. The polarity switch SW7 allows random access of any EDLC in the array to be connected to the shuttle inductive element Ls. Whereby in this embodiment the inductive element siphons energy off of the whole array, switched by SW8, and shuttles that charge to the selected EDLC within the array.

The Switch Control Circuitry 15 may use a number of algorithms to test each EDLC against the rest in the array, and redistribute amongst the array. In a simple embodiment the capacitors are sequentially tested one against another in a continuous loop. After each test, the CS shuttles charge between adjacent pairs of EDLCs if the SOC difference between them is greater than the threshold voltage. The shuttling occurs for either a set number or adaptive number of cycles before continuing the circular sequential testing. A simplified version of this embodiment doesn't require the testing of each capacitor against another, but rather just shuttles between each capacitor successively in round-robin fashion eventually balances the array. In another embodiment the circuitry sequentially searches for the highest and lowest SOC EDLC pair to shuttle between, then repeats with the next highest and lowest SOC pair. In another embodiment, the highest SOC capacitor is located, after which charge is shuttled between it and the lower SOC capacitors in the array.

While the EDLCs are tested as described above, the circuit Diff2 reads the voltage across the EDLC in test, and relays it to Comp2 which compares the voltage to the TOC threshold voltage set by Ref2. If the voltage exceeds the reference voltage the output of Comp2 signals the network via the network terminal 13 that TOC terminal as conveyed by the transceiver Trans1. Given the switched matrix logic isn't necessarily static, the Switch Control Circuitry 15 may latch the output of Comp2 until the capacitor at SOC is tested to be below the hysteresis set point, at which point the signal is cleared. Trans may by a two-way transceiver, or in the simplest case a top-of-charge indicator to signal the charge controller to stop charging, with no two way logic.

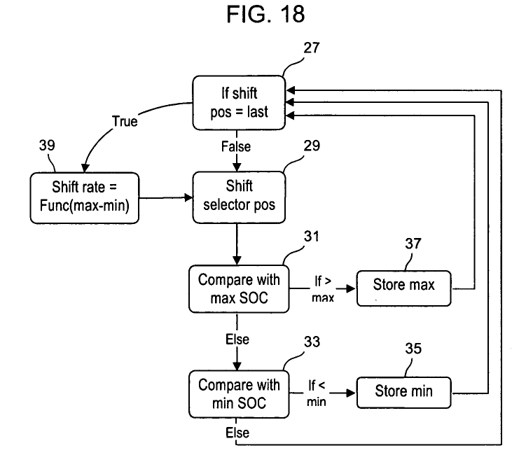

One embodiment of the above switch control circuitry logic can be seen in the state block diagram in FIG. 18. In this embodiment, the switch pairs of the switch matrix are selected in secession, each time connecting the shuttle capacitor in parallel with the selected capacitor. The logic entry starts by checking if the shifter position is at the end of the array 27, if its not, the selector is shifted 29 to the next EDLC in the array. The selected EDLCs voltage is then compared with the maximum voltage 31 and the minimum voltage 33 detected so far for current round of shifting. If the current EDLC is greater than the maximum 31 or less than the minimum 33, the voltage of the current capacitor is stored in the appropriate bin 35, 37. The cycle repeats until the shifter reaches the end of the array, at which point the logic branches to set the shift rate 39 as function of the difference between the max and min capacitor stored values, after which the values are cleared. If the values are within a small margin, the shift rate is set very low as to effectively put the circuit to sleep.

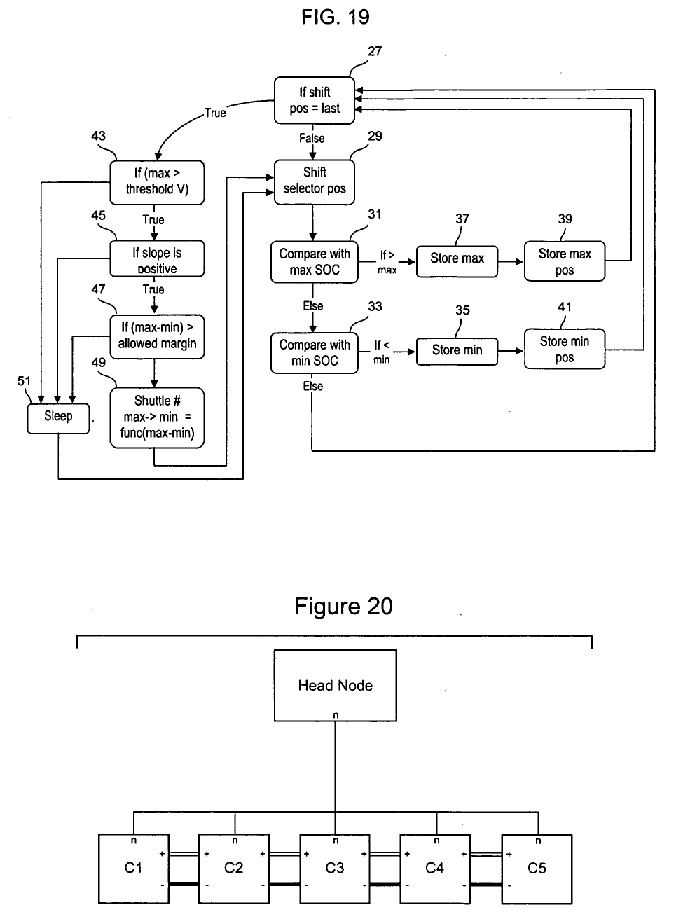

Another embodiment of the above switch control circuitry logic can be seen in the state block diagram in FIG. 19. In this embodiment, the switch matrix is scanned to find the highest and lowest voltage EDLCs, after which the charge is shuttled between them an adaptive number of cycles. The logic entry starts by checking if the shifter position is at the end of the array 27, if its not, the selector is shifted to the next EDLC in the array 29. The selected EDLCs voltage is then compared with the maximum voltage 31 and the minimum voltage 33 for current round of shifting. If the current EDLC is greater than the maximum 31 or less than the minimum 33, the voltage 35, 37 and the position of the current capacitor 39, 41 is stored in the appropriate bin. The cycle repeats until the shifter reaches the end of the array, at which point the logic branches to test whether the stored max voltage is greater than the threshold voltage 43, if it is, the voltage of the pair (max+min) or the average of the whole array is tested as to the direction of the slope 45, determining whether the device charging or discharging. If the sloped is positive, then the difference between the max and min capacitors is calculated 47 to determine whether balancing is necessary. If it is, the charge between the saved positions is shuttled a number of cycled determined by a function of the difference between them 49. If the above tests fail, the circuit is put to sleep 51 for a preset or an adaptive amount of time, after which the process starts again.

### Module Embodiments

The present invention provides methods of constructing modules having a single enclosure comprising an EDLC array and balancing circuitry. It is preferred that the module has a means of networking to communicate with other such modules or the head node in a capacitor network. It is also preferred that the enclosure housing these elements be hermetically sealed.

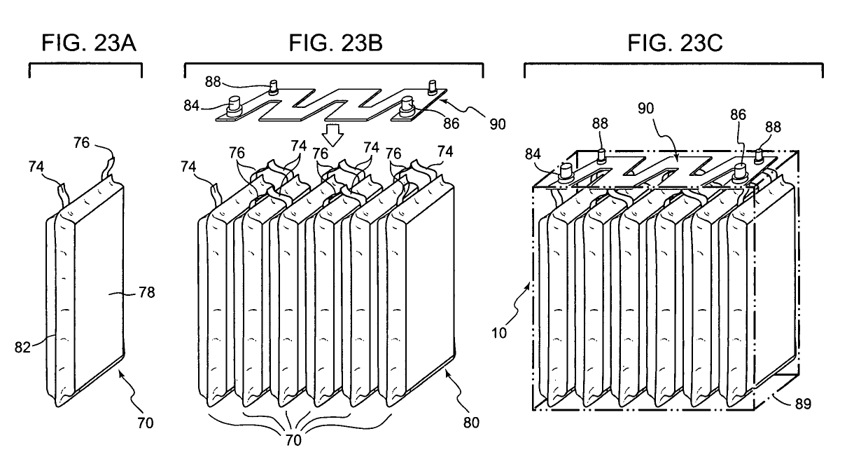

In one such embodiment a type of capacitor module 10, FIG. 23C, is constructed using a multiplicity of unit cells 70, FIG. 23A. Where each of the unit cells 70 in FIG. 23A comprises a positive polarizable electrode and a negative polarizable electrode (not shown) which are formed on or conductively attached to two collectors which provide conduction of the electricity out of the cell leading out through electrical leads 74 and 76. The unit cell further comprises an optional separator which is interposed between the polarizable electrodes to provide electrical isolation between said electrodes while allowing electrolyte conductivity.

As shown in FIG. 23A, the unit cell 70 is then sealed in a polymer, elastomer, foil or foil-polymer package 78, filled with an organic electrolyte and the edges sealed 82, forming a enclosed unit cell 70, having electrical leads 74, 76 emerging from the package. A multiplicity of packaged unit cells 70 are then assembled in an array, such as the series assembly shown in FIG. 23B. Wherein the cell leads 74, 76 are alternatively connected in series, positive to negative. The balancing control circuit board 90 is then connected to each terminal or terminal pair. The circuit board may have the module terminals attached as in this example, having a positive and negative stack terminals or terminal attachments 84 and 86. Further the circuit board may contain a one or more network terminals or terminal attachments 88. Or alternatively the terminals may be pre-molded, machined, or fitted into the module enclosure 10, to which the balancing circuitry is attached.

After assembly, the array and balancing circuitry are enclosed in an preferably air-tight container 89, FIG. 23C to form a singular packaged unit 10 having positive and negative terminals 84, 86 which are electrically attached to the end leads of the multi-cell array. The module also may have network terminal protruding through the case, if the circuitry operates in networked fashion. The terminals in either case are preferably hermetically sealed to the enclosure.

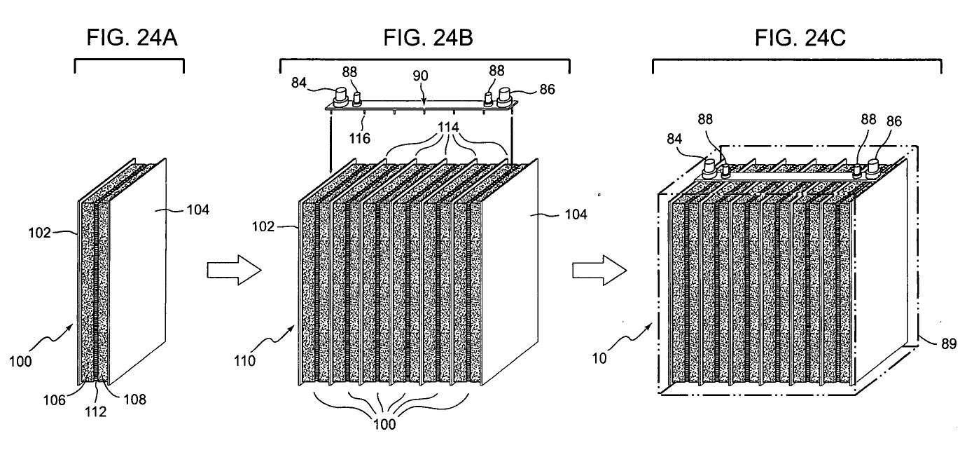

In another such embodiment, a type of bipolar capacitor module 10, FIG. 24C, is constructed using a multiplicity of unit cells 100, as shown in FIG. 24A. Where each of the unit cells 100 in FIG. 24A comprises a positive polarizable electrode 106 and a negative polarizable electrode 108 which are formed on or conductively attached to two collectors 102 and 104, which provide conduction of the electricity out of the cell. The unit cell further comprises an optional separator 112 which is interposed between the polarizable electrodes 106 and 108 to provide electrical isolation between said electrodes while allowing electrolyte conductivity.

As shown in FIG. 24B, a multiplicity of unit cells 100 are stacked in a bipolar arrangement 110, such that each positively polarized electrode shares an electrical collector 114 with the negatively polarized electrode of the adjacent cell as to conduct electricity through the full face of the collector, each cell in turn until the end cells terminate in the end collectors 102 and 104. A circuit board 90 having charge balancing circuitry, and having a means 116 of electrically connecting to each of the bipolar current collectors 114, 102 and 104. Further the circuit board 90 may have module terminals 84 and 86 attached or they may be separate. Further the circuit board 90 may have network terminals 88 attached or it may provide a means of electrical connection to the network terminal placed elsewhere.

The assembled stack 110, is immersed in, or filled with an organic electrolyte and then sealed in an enclosed air-tight container 89, FIG. 24C, to form a singular packaged module 10 having positive and negative terminals 84, 86 which are electrically attached to the end collectors of the multi-cell stack. The module also may have network terminal(s) protruding through the case, if the circuitry operates in networked fashion. The terminals in either case are preferably hermetically sealed to the enclosure.

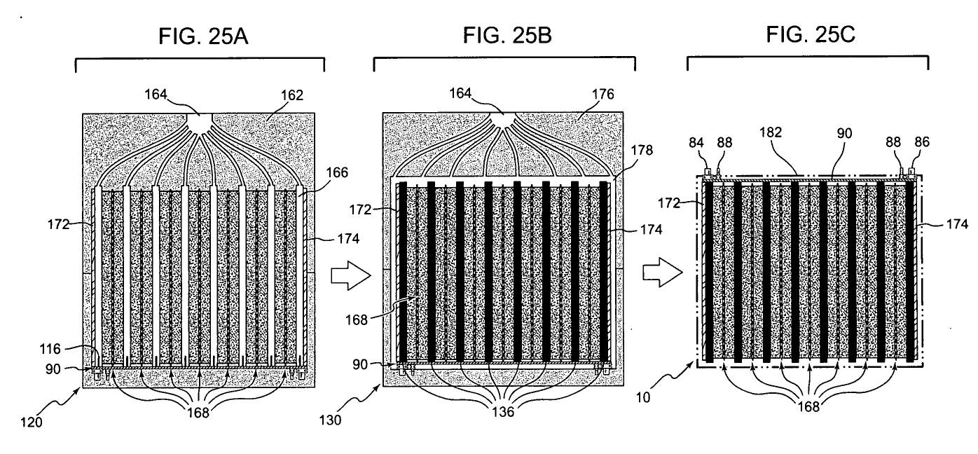

One method of manufacturing the above bipolar embodiment is shown in FIG. 25A-25C. Wherein a type of bipolar capacitor module 10, FIG. 25C, is constructed using a multiplicity of unit cells 168 in FIG. 25A. Where each of the unit cells 168 comprises a positive polarizable electrode and a negative polarizable electrode and an optional separator, all as previously described according to the present invention. In this embodiment the unit cells are placed in an injection mold frame 162 of an injection molding machine 120, such that the injection mold frame holds said unit cells in place, and having open chambers 166 with the dimensions desired for the polymer current collectors. And wherein the mold frame has an open chamber to hold a circuit board 90 containing cell balancing circuitry as embodied in the current invention. Wherein the circuit board has a means of electrical connection 116 to the current collectors once they are molded in place. Wherein the means of electrical connection may be a metal or conductive polymer pin or contact. Whereby the polymer, containing conductive additive(s) is thereafter injected into the open chambers 166 by way of plastic injection channels 164 as to fill the individual void spaces between unit cells 168 and optional metal terminal plates 172, 174. Wherein the conductive polymer bonds to the electrodes of the unit cells 168. The terminal plates 172, 174, in the preferred embodiment, being comprised of a metal or metal alloy, most preferably aluminum, provide means as to electrically connect the bipolar stack of cells, sealed in the polymer housing, to external connections. The terminal end plates being sealed from the cell.

After the current collector conductive polymer material is injected into the open chambers, the stack is either moved into a second mold frame 176 of the molding machine 130, FIG. 25B, or left within the same mold frame 176 having movable parts as to change the shape of the spaces 178 of the mold cavity as to prepare it for injection molding of the non-conductive enclosure around the now formed current collectors 136. Injecting the nonconductive polymer enclosure around the individual cells and current collectors, seals the individual cells from one another and the metal terminal end plates, while leaving a small opening in the top of each cell. Wherein terminals protruding from the case carry the current from the stack of cells to an external power and network terminals.

After removing the stack from the injection mold cavity the cells are filled with an electrolyte through remaining openings in each cell which after filling are sealed shut. The network terminals 88, FIG. 25C of the control circuitry 90 protrude through the sealed enclosure 182. The power terminals 84, 86 connected to the terminal current collectors 172, 174 also protrude through the sealed enclosure 182. The enclosed stack may then be coated with a metal, ceramic, or plastic coating which inhibits the moisture permeability of the enclosure. Alternatively, the enclosed stack may be wrapped or enclosed in a sheet metal, metal foil or metal foil-polymer and then welded, heat sealed, crimped, or seal by another means. After which, the enclosure may be placed back into the mold frame 176 to have another thickness of polymer overmolded around the metal. Or the metal foil may be placed in the initial enclosure molding, FIG. 25B as discussed above, positioned such that the polymer flows on both sides of the foil as to both seal the housing and provide a vapor barrier. Or alternatively, the case may be placed in a metal container, with electric terminal feedthroughs, and hermetically welded closed.

The carbon material, which is used for the electric double layer capacitor electrodes 76, 78 according to the embodiment of the present invention, wherein may be comprised of a carbon, activated carbon, and carbon black, graphitic carbon, alkali activated graphitic or non-graphitic carbon (processed at high temperatures with alkalis such as KCO3, KOH, K, Na, NaOH, NaCO3, etc), carbon fibers, carbon nanotubes, carbon fibrils, or a combination thereof. And wherein such carbons or mixtures thereof may also contain a fluorine-containing polymer, as a binding agent, such as polytetrafluoroethylene (PTFE), an ethylene-tetrafluoroethylene copolymer (ETFE), a chlorotrifluoroethyl-ethylene polymer (PCTFE), a vinylidene fluoride copolymer (PVDF), a tetrafluoroethylene-hexafluoropropylene copolymer (FEP), or a tetrafluoroethylene-perfluoroalkylvinyl ether copolymer (PFA). Or the binder may also be comprised of a polyolefin polymer or co-polymer, such as polypropylene, polyethylene, ethylene-octene, or ultra high molecular weight polyethylene.

Alternatively, the carbons may be bound together with carbon-bearing substance, emulsion or adhesive—then formed into blocks or sheets and processed into a conductive electrode at high temperature. The high temperature process pyrolyzation leaves behind only a conductive carbonaceous remnant of the binder. Such carbon bearing substances include methyl cellulose, polyvinylidene difluoride, pitches, coal tar, petroleum tar, asphaltenes, fly ash, cellulose, starches, and proteins. Preferred carbon-bearing substances being thermosetting resins, such as phenolic, resorcinol, or furfural resins. Alternatively, the carbon may be produced as a monoblock, formed from carbon bearing precursors such as methyl cellulose, polyvinylidene difluoride, coal tar, pitches, petroleum tar, cokes, asphaltenes, fly ash, cellulose, starches, proteins, phenolic resins, furfural resins, and epoxide resins and then carbonized to form a solid electrode.

The electrostatic capacity of the electrode, expressed in farads, is developed between the solute ions of the organic electrolyte and the carbon of the electrode, whether the ions forming the electrostatic storage field are adjacent the carbon surface, diffuse, absorption on the carbon surface, or through insertion between carbon layers.

In this embodiment it is preferable that the solute of the organic electrolyte includes, but is not limited to, one of the following anions: tetrafluoroborate (BF4-), of hexafluorophosphate (PF6-), hexafluoroarsenate (AF6-), perchlorate (ClO4-), CF3SO3-, (CF3SO2)2N—, C4F9SO3-. Wherein it is also preferable that the solute of the organic electrolyte includes, but is not limited to, the following cations.

One such cation may be represented by the following formula:

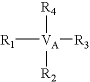

Wherein the central atom VA is one of the periodic table group VA elements (N, P, As . . . ) and where the four radicals R1, R2, R3, R4 may individually support one of the following groups: methyl, ethyl, propyl, butyl, or pentyl. Examples include tetraethylammonium (Et4N+) and 1-methyl-3-ethylphosponium (Et3MeP+). Or wherein any two of the radical attachment points may support a cyclic hydrocarbon, examples include dialkylpyrrolidinium or dialkylpiperidinium.

Another such cation can be represented the the following formula.

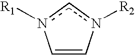

Wherein R1 and R2 are alkyl groups each having a number of carbon atom or atoms of 1 to 5, R1 and R2 may be the same group or different groups. An example of which is 1-ethyl-3-methylimidazolium.

It is preferable that the solvent of the organic electrolyte be a dipolar aprotic solvent. Which may include, propylene carbonate (PC), butylenes carbonate (BC), ethylene carbonate (EC), gamma-butyrolactone (GBL), gamma-valerolactone (GVL), glutaronitrile (GLN), adipnitrile (ADN), acetonitrile (AN), sulfolane (SL), trimethyl phosphate (TMP), dimethyl carbonate (DMC), ethyl methyl carbonate (EMC), or diethyl carbonate (DEC).

It is also allowable to use a solvent comprised of a mixture composed of a primary solvent containing at least one aprotic solvent, such as those mentioned above, and a secondary solvent containing either another of said dipolar aprotic solvents, or another non-polar organic co-solvent.

It is also allowable that with the use of ionic liquids, such as the aforementioned imidazolium cation containing ionic liquids, the electrolyte may contain only a neat ionic liquid, and no other solvent. It is also allowable that the ionic liquid also contains a co-solvent. Or it is also allowed that the ionic liquid co-solves another solute of dissociatable cations and anions.

3. Objects and Advantages

The present invention provides a novel method of producing an electric double layer capacitor module having a single enclosure containing an EDLC array, balancing circuitry, and a means of networking said circuitry to other such modules or controllers. The present invention improves the state of the art by providing a capacitor array having only one air-tight enclosure, with only two hermitically sealed power terminals and zero, one, or more hermetically sealed network terminals depending on the implementation. These improvements significantly reduce system cost, by reducing hermetic terminal count and packaging materials, while simplifying end-user operation and installation.

For instance a 20 cell stack would only need two power terminals and one network terminal (in one embodiment) having a single hermetic enclosure, whereas the prior art would require 20 separate cells each having its own hermetic enclosure, and each having 2 power terminals for a total of 40 hermetically sealed electrical feedthroughs. When utilized by the end user the present invention can be used in an ad-hoc manner, the charge balancing circuits automatically networking one module to another, whereas the prior art would require the user to wire each cell into a custom array, then wiring each of those cells to the cell balancing circuits, typically of custom or semi-custom design.

Further the present invention reduces wasted space of excess packaging, thus increasing the specific energy of the array.

Further the present invention provides novel methods of balancing the charge within the array that utilize low-power low cost components, reducing cost.

It is a matter of course that the electric double layer capacitor modules, the balancing circuitry, balancing methods, and the methods for producing the same, according to the present invention are not limited to the embodiments described above, which may be embodied in other various forms without deviating from the gist of essential characteristics of the present invention.

What is claimed is:

1. An electric double layer capacitor module comprising:
an array of the least two electric double layer capacitor cells;
an embedded cell balancing circuit; and
a means of networking the embedded cell balancing circuit to another such circuit of another such module or charge controller;
wherein said capacitors, balancing circuits, and means of networking are all housed in a single enclosure;

2. The enclosure of claim 1, wherein the enclosure may comprise a barrier layer forming an air-tight seal, such that the capacitor and circuitry is contained within the air-tight seal.

3. The enclosure of claim 2, wherein the enclosure comprises a container, foil, laminate, or coating selected from the group consisting of a metal, ceramic, or polymer laminate forming a substantially hermetic barrier

4. The electric double layer capacitor module of claim 1, wherein the terminal ends of the electric double layer capacitor array are electrically connected to two power terminals as provided by electrical feed-throughs projecting through the enclosure envelope or electrically conducting terminal surfaces integral to the module enclosure.

5. The electric double layer capacitor module of claim 1, wherein the means of networking comprises one or more terminals connected internally to the embedded cell balancing circuitry and electrically connected to terminals as provided by electrical feed-throughs projecting through the enclosure envelope or electrically conducting terminal surfaces integral to the module enclosure.

6. The charge balancing circuitry of claim 1, wherein the circuitry has a switched bypass device connected in parallel across each of the double layer capacitors in the modules capacitor array.

7. The switched bypass device of claim 6, wherein the device may selected from the group consisting of transistors, MOSFETS, FETS, IGBTS, photo-coupled diodes, photo-coupled transistors, and relays.

8. The switched bypass device of claim 6, wherein the device may further comprise a resistor and/or diode.

9. The switched bypass device of claim 6, wherein the switch is pulse modulated.

10. The switched bypass device of claim 6, wherein the bypass switching is engaged while the electric double layer capacitor of the module having the highest voltage is above a minimum voltage threshold.

11. The charge balancing circuitry of claim 1, wherein the circuitry has at least one switched intermediary energy storage element, which can be switched into electrical parallel with any of the double layer capacitors in the module array via a switch matrix, whereby allowing charge shuttling between said double layer capacitors via the intermediary storage capacitor.

12. The intermediary energy storage element of claim 11, wherein the element may be comprised from at least one of the group: capacitors, inductors, and transformers.

13. The charge shuttling of claim 11, wherein the charge shuttling between capacitors in the array is engaged only while a capacitor of the module is above a minimum voltage threshold.

14. The voltage threshold of claim 13, wherein the threshold voltage comprises a hysteresis function, such that the charge shuttling between capacitors in the array is engaged only while a capacitor of the module is above minimum voltage threshold during charge, but disengages at a higher voltage threshold during discharge.

15. The embedded cell balancing circuitry of claim 11, wherein the each of the cells in the array of electric double layer capacitors are compared in pairs, one to another, by a voltage comparison circuit such that if difference between any pair exceeds a threshold voltage, the higher of the two electric double layer capacitors is connected in parallel with an intermediary energy storage element, charging said storage element, then disconnected, and then connected in parallel with the electric double layer capacitor of lower charge.

16. The embedded cell balancing circuitry of claim 15, wherein the charge shuttling sequence is repeated an adaptive number of times between the same two electric double layer capacitors before continuing on to test other pairs of double layer capacitors in the array.

17. The embedded cell balancing circuitry of 11, wherein after the circuitry determines the highest and lowest voltage electric double layer capacitor cells in the series array, and if the difference in voltage between those cells is greater than a threshold voltage, the circuit shuttles charge between the two.

18. The embedded cell balancing circuitry of claim 15, wherein the voltage comparison circuitry compares each adjacent pair of capacitors in the array, in circular fashion such that at the end of the array the last capacitor is compared to the first capacitor at the beginning.

19. A network of the double layer capacitor modules described in claim 1, networked together where a signal or message from any one of said capacitor modules indicates to an external charge controller to stop charging the plurality of electric double layer capacitor modules in the network.

20. A method of networking a parallel array of at least one double layer capacitor modules as described in claim 1, wherein each capacitor module has two power terminals, and a network terminal; wherein the modules in the array are connected together in electrical parallel with a charge controller, and the network terminals of each module are connected to each other and also to the charge controller, such that the charge controller charges the array of modules until one module signals that a electric double layer capacitor within the module enclosure has reached top-of-charge at which point the controller stops charging the array.
